(19) United States
(12) Patent Application Publication
(10) Pub. No.: US 2025/0229583 A1
(43) Pub. Date: Jul. 17, 2025

(54) HITCHING DEVICE, MOTOR VEHICLE, TRAILER AND CARRIER SYSTEM

(71) Applicant: AUDI AG, Ingolstadt (DE)

(72) Inventor: Sebastian VAHLE, Landshsut (DE)

(73) Assignee: AUDI AG, Ingolstadt (DE)

(21) Appl. No.: 18/871,727

(22) PCT Filed: May 23, 2023
(86) PCT No.: PCT/EP2023/063785

§ 371 Date: Dec. 4, 2024

(30) Foreign Application Priority Data
Jun. 9, 2022 (DE) 10 2022 114 539.5

(51) Int. Cl. B60D 1/28; B60D 1/62; G07C 5/00

(52) U.S. Cl. CPC B60D 1/28; B60D 1/62; G07C 5/008

(57) ABSTRACT

The present disclosure relates to a trailer coupling having a coupling body for forming a motor vehicle/trailer coupling, wherein the coupling body has an electromagnet for generating a magnetic holding force as a safeguard against accidental or unauthorized separation of the motor vehicle/trailer coupling. A control unit is provided, which is configured in such a manner that a charge state of a battery for supplying the electromagnet with electrical power is monitored at least when the electromagnet is activated.

### TECHNICAL FIELD

The present disclosure relates to a trailer coupling. Furthermore, the present disclosure relates to a motor vehicle, to a trailer and to a carrier system.

### BACKGROUND

Various trailer couplings are available for the motor vehicle sector that are used to create a coupling between a towing vehicle and a trailer. Such trailer couplings are therefore also referred to as trailer hitches. In the passenger car sector, what are known as ball head couplings are particularly common.

### BRIEF DESCRIPTION OF DRAWINGS/FIGURES

Further advantages, features, and details of the present disclosure arise from the claims, from the following description of preferred embodiments, as well as with reference to the schematic drawing. In the figures:

FIG. 1 shows, in a block diagram representation, a motor vehicle with a trailer coupling; and

FIG. 2 shows, in a side view, the trailer coupling.

Parts corresponding to one another are provided with the same reference signs in all figures.

### DETAILED DESCRIPTION

It is an object of the present disclosure to specify an advantageous design of a trailer coupling. It is also an object of the present disclosure to specify an advantageous design of a motor vehicle, an advantageous design of a trailer and an advantageous design of a carrier system.

This object is achieved by a trailer coupling having the features of claim 1, by a motor vehicle having the features of claim 6, by a trailer having the features of claim 8, and by a carrier system having the features of claim 9. The advantages and preferred embodiments mentioned with respect to the trailer coupling can also be transferred analogously to the other devices, i.e., the motor vehicle, the trailer and the carrier system, and vice versa. Advantageous embodiments having useful further developments of the present disclosure are specified in the dependent claims.

The trailer coupling according to the present disclosure is intended for the motor vehicle sector, in particular for battery-powered motor vehicles (partially electric (hybrid) or fully electric), and has a coupling body for forming a motor vehicle/trailer coupling. In the context of this application, the term motor vehicle/trailer coupling refers to a coupling between a motor vehicle on the one hand and a trailer or carrier system, such as what is known as a bicycle carrier, on the other hand. The trailer coupling is therefore preferably not used exclusively to connect a towing vehicle to a trailer. Rather, depending on the design variant, the trailer coupling is alternatively or additionally designed to attach a previously mentioned carrier system to a motor vehicle. In particular, the design of the trailer coupling allows a carrier system to be attached to a motor vehicle or a towing vehicle to be connected to a trailer as required.

Independently of this, the coupling body has at least one electromagnet, which is preferably integrated into the coupling body. In this case, the electromagnet is expediently part of an electrical device of the trailer coupling, or forms such a device. In this case, if necessary, the electromagnet serves to generate a magnetic holding force for retaining or securing the motor vehicle/trailer coupling against accidental and/or unauthorized separation. This means that the magnetic holding force is provided to prevent accidental and/or unauthorized separation of the motor vehicle/carrier coupling.

The trailer coupling is preferably designed in such a way that the magnetic holding force is provided and/or usable only as a safeguard of the previously mentioned type. This means that the magnetic holding force is preferably not required in order to use the motor vehicle/trailer coupling for an application while driving. For this purpose, the trailer coupling instead preferably has a design which enables a sufficiently stable and secure mechanical connection when a motor vehicle/trailer coupling is formed. This preferably applies regardless of whether the coupling connects a motor vehicle to a trailer or a motor vehicle to a carrier system.

It is further expedient if the trailer coupling has at least one operating element, by means of which the electromagnet can be activated and/or deactivated. The corresponding operating element is then part of the electrical device of the trailer coupling and, for example, is formed by a switch or pushbutton.

Further preferably, the at least one operating element is positioned such that it is protected against unauthorized access-for example, by the operating element being arranged behind a closeable flap. If the trailer coupling is part of a motor vehicle, the corresponding operating element is preferably arranged in the passenger compartment of the motor vehicle, i.e., for example, in the region of a center console or on the inside on a vehicle door of the motor vehicle. According to an alternative embodiment, the corresponding operating element is positioned behind a so-called gas tank flap. If the trailer coupling is part of a trailer, the at least one operating element is preferably positioned in the region of an interior of the trailer, in particular if the corresponding trailer is designed as what is known as a caravan or mobile home.

Alternatively or additionally, the trailer coupling is configured in such a manner that the electromagnet, i.e., the at least one electromagnet, can be activated by radio signals of a transmitting unit. For this purpose, the electrical device of the trailer coupling then has a receiving unit which is designed to receive corresponding radio signals. The transmitting unit is then typically part of an operating unit which is designed, for example, as a kind of remote control, i.e., in particular, in the manner of a garage opener, as a vehicle key, or as a smartphone, on which a specific operating app is then typically installed.

Furthermore, it is expedient for the trailer coupling and in particular the electrical device to have at least one display element, i.e., for example, a light-emitting diode. The corresponding display element then expediently serves to indicate when the electromagnet is activated, i.e., is supplied with electrical power. In this case, a variant is preferred in which a corresponding display element is arranged on the coupling body or is integrated into the coupling body.

If the electromagnet, as described above, can be activated and deactivated by radio signals, the trailer coupling and, in particular, the electrical device, also preferably have not only a receiving unit, but a transmitting and receiving unit. In this case, the electrical device of the trailer coupling is then typically set up in such a way that, in the course of activation of the electromagnet, a radio signal with which the activation is confirmed is transmitted. The electrical device of the trailer coupling is then expediently configured in such a way that, in the course of deactivation of the electromagnet, a radio signal is likewise transmitted, with which the deactivation is confirmed.

A further advantage is a design of the trailer coupling in which it is designed for use with passenger cars, in particular for battery-powered (partially electric (hybrid) or fully electric) motor vehicles. In this case in particular, the trailer coupling is designed in the manner of a ball-head trailer coupling and the coupling body usually has a ball head, i.e. a body whose outer surface corresponds, at least to a good approximation, to the surface of a sphere. If at least one electromagnet is integrated into the trailer coupling, it is typically arranged in an interior space of the ball head.

In an advantageous further development, the coupling body then also has an arm which carries the ball head. Preferably, a previously described display element is integrated into the arm or a corresponding display element is positioned on the arm.

Irrespective of this, the at least one electromagnet is preferably arranged and aligned such that the magnetic holding force acts at least predominantly in a vertical direction with respect to the ground system.

In order to supply the at least one electromagnet with electrical power, the trailer coupling, and in particular the electrical device of the trailer coupling, typically have a battery. Alternatively, the trailer coupling, and in particular the electrical device of the trailer coupling, has at least one interface via which electrical power can be supplied, so that the at least one electromagnet can be fed electrical power.

Furthermore, an embodiment is preferred in which the electromagnet is designed for operation with AC voltage. In this case, the support apparatus and in particular the electrical device of the support apparatus then preferably have an inverter for converting a DC voltage into an AC voltage for the at least one electromagnet. Alternatively, the electromagnet is designed for operation with a DC voltage. In this case, the support apparatus and in particular the electrical device of the support apparatus preferably has a DC-DC converter.

If the support apparatus is part of a motor vehicle, the electrical device of the support apparatus is expediently part of an onboard electrical system of the motor vehicle, for example a battery-operated (partially electric or fully electric) motor vehicle. In this case, the at least one electromagnet is then supplied with electrical power via the onboard power supply system of the motor vehicle. A battery of the motor vehicle then typically serves as an energy source for the electromagnet and in particular the entire electrical device of the support apparatus. Depending upon the embodiment variant, the battery is a so-called high-voltage battery (HV battery) or a so-called low-voltage battery (LV battery). In some applications, the battery is then an additional battery which is additionally installed for supplying the at least one electromagnet with electrical power, and, in particular, the entire electrical device of the support apparatus.

If the support apparatus is part of a trailer, the electrical device of the support apparatus is expediently part of an onboard electrical system of the trailer. In this case, the at least one electromagnet is then supplied with electrical power via the onboard power supply system of the trailer. A battery of the trailer then typically serves as an energy source for the electromagnet and in particular the entire electrical device of the support apparatus.

In an advantageous further development, the trailer coupling and in particular the electrical device of the trailer coupling then have a control unit which is configured to monitor the charge state of the battery at least during operation of the electromagnet, i.e., when the electromagnet is activated. If the trailer coupling is part of a motor vehicle, at least the motor vehicle preferably has a control unit configured for this purpose.

In addition, the control unit is configured in such a manner that, at least when the electromagnet is activated, a measured value representative of the charge state is determined; that a threshold value, viz., a first threshold value, is predetermined or prespecified—typically, independently of the operating state of the electromagnet. At least when the electromagnet is activated, a number of actions are automatically carried out if the measured value falls below the first threshold value. This is advantageous in particular if the trailer coupling is part of a motor vehicle.

The aforementioned number of actions further preferably include at least one of the following actions: sending a notification to a recipient, reducing the electrical power supplied to the electromagnet, or deactivating the electromagnet and thus ending the supply of electrical power.

In this case, the control unit described above is expediently configured to carry out the number of actions automatically, or at least to initiate the execution thereof.

If sending a notification is provided as an action, it is typically transmitted by means of the aforementioned transmitting and receiving unit by radio signal, i.e., for example, as a message to a smartphone. If a reduction in the electrical power for the supply of the at least one electromagnet is provided, an adjustment in steps is typically realized. This means that at least two supply levels are provided which differ with respect to the voltage values and/or current intensities.

For the action of deactivating the electromagnet, a second, smaller or lower, threshold value can be prespecified or is prespecified according to a further embodiment, so that this action is only carried out automatically if the value drops below the second threshold value. Independently of this, this action is particularly advantageous if the battery is part of an onboard electrical system of a motor vehicle, and is not exclusively used for supplying the electromagnet and the electrical device of the trailer coupling.

In an advantageous development, the first threshold value and/or the second threshold value can be predetermined via the previously mentioned operating unit, i.e., for example, via the aforementioned operating app on a smartphone, or via an onboard computer of a motor vehicle.

As already at least previously indicated, depending on the design variant, the trailer coupling is part of a motor vehicle, in particular a battery-operated and partially or fully electric vehicle, part of a trailer or part of a carrier system, for example what is known as a bicycle carrier.

If the trailer coupling is part of a motor vehicle, it is also preferably configured in such a way that, when the electromagnet is activated, i.e., when the supply of electrical power to the electromagnet is activated, the electromagnet is automatically deactivated, i.e., the supply is automatically terminated, when a vehicle start is carried out, i.e., for example, a drive motor of the motor vehicle is started.

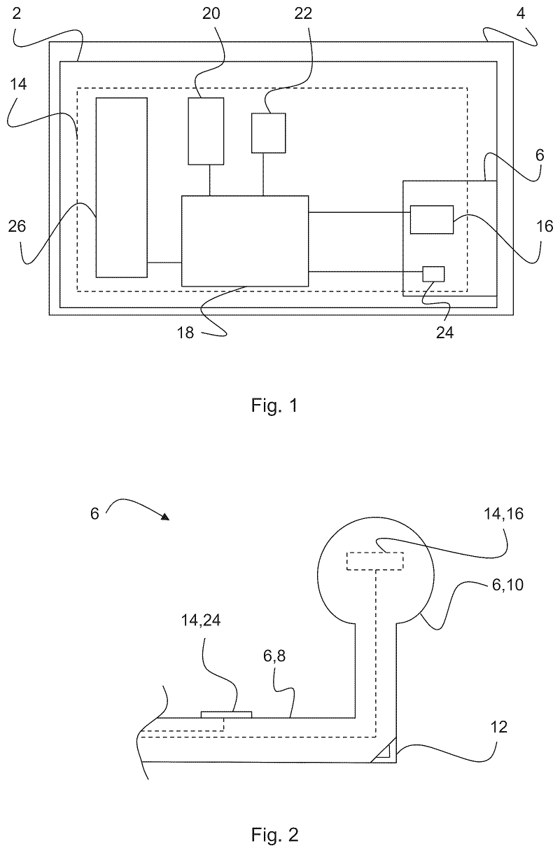

A trailer coupling 2 described by way of example below is part of a motor vehicle 2 shown schematically in FIG. 1, in particular a battery-operated (partially electric (hybrid) or fully electric) motor vehicle, and has a coupling body 6 for forming a motor vehicle/trailer coupling. The trailer coupling 2 is designed in the manner of a ball head trailer coupling and has an arm 8 and a ball head 10 positioned at the end of the arm 8. In the exemplary embodiment, part of the arm 8 is an eyelet for attaching a safety rope or brake rope, as shown in FIG. 2.

The trailer coupling 2 further comprises an electrical device 14. Part of this electrical device 14 is an electromagnet 16, which is integrated into the ball head 10. The electromagnet 16 is positioned and aligned in such a way that a magnetic holding force can be generated which acts at least substantially in a vertical direction with respect to the ground system. The magnetic holding force serves as a safeguard against accidental and/or unauthorized separation of the motor vehicle/trailer coupling.

Furthermore, the electrical device 14 is part of an onboard electrical system of the motor vehicle 4, and, in the exemplary embodiment, comprises a control unit 18, an operating element 20, a transmitting and receiving unit 22, a display element 24, and a battery 26.

In the exemplary embodiment, the operating element 20 is designed as a pushbutton which is positioned behind a fuel tank flap of the motor vehicle 4 in a manner not shown in detail. By actuating the pushbutton, the electromagnet 16 can then be activated and deactivated.

According to the exemplary embodiment, the display element 24 is designed as a light-emitting diode and is positioned on the arm 8 of the coupling body 6. Preferably, the light-emitting diode is recessed in the arm 8 and thus integrated into the arm 8.

The control unit 18 is expediently configured in such a manner that it activates the display element 24 when the electromagnet 16 is activated and deactivates it when the electro-magnet 16 is deactivated.

Furthermore, the control unit 18 is preferably configured to control the transmitting and receiving unit 22 and to process radio signals received by the transmitting and receiving unit 22. The motor vehicle 4 is then additionally configured for activation and deactivation of the electromagnet 16 by radio signals, which are transmitted, for example, from a remote control, an automobile key, or a smartphone.

In addition, the motor vehicle 4 is preferably configured to transmit status notifications via radio signals by means of the transmitting and receiving unit 22, and, in fact, in particular every time the electromagnet 16 is activated or deactivated. The status notifications are in particular designed such that they can be processed by an operating app on a smartphone.

The battery 26 supplies the electrical device 14, and in particular the electromagnet 16, as needed.

### LIST OF REFERENCE NUMBERS

2 trailer coupling
4 motor vehicle
6 coupling body
8 arm
10 ball head
12 eyelet
14 electrical device
16 electromagnet
18 control unit
20 operating element
22 transmitting and receiving unit
24 display element
26 battery

1.-9. (canceled)

10. A trailer coupling comprising:
a coupling body configured to form a coupling between a trailer and a motor vehicle, wherein the coupling body comprises:
a ball head; and
an electromagnet arranged in an interior space of the ball head and configured to generate a magnetic holding force as a safeguard against accidental or unauthorized separation of the coupling between the motor vehicle and the trailer.

11. The trailer coupling according to claim 10, wherein the coupling body comprises a display element configured to display an operating state of the electromagnet.

12. The trailer coupling according to claim 10, further comprising a control unit configured to monitor a charge state of a battery for supplying the electromagnet with electrical power, at least when the electromagnet is activated.

13. The trailer coupling according to claim 12, wherein the control unit is configured to:
determine a measured value representative of the charge state at least when the electromagnet is activated; and
automatically carry out a plurality of actions when the measured value falls below a predetermined threshold value.

14. The trailer coupling according to claim 13, wherein the plurality of actions comprise at least one of the following actions:
sending a notification to a recipient,
reducing the electrical power supplied to the electromagnet, or
deactivating the electromagnet.

15. A motor vehicle, comprising:
a trailer coupling, comprising:
a coupling body configured to form a coupling between a trailer and a motor vehicle,
wherein the coupling body comprises:
a ball head; and
an electromagnet arranged in an interior space of the ball head and configured to generate a magnetic holding force as a safeguard against accidental or unauthorized separation of the coupling between the motor vehicle and the trailer.

16. The motor vehicle according to claim 15, wherein the electromagnet is configured to automatically deactivate when a vehicle start is carried out.

17. A trailer comprising:
a trailer coupling comprising:
a coupling body configured to form a coupling between a trailer and a motor vehicle, wherein the coupling body comprises:
a ball head; and
an electromagnet arranged in an interior space of the ball head and configured to generate a magnetic holding force as a safeguard against accidental or unauthorized separation of the coupling between the motor vehicle and the trailer.

18. A carrier system comprising:
a trailer coupling comprising:
a coupling body configured to form a coupling between a trailer and a motor vehicle, wherein the coupling body comprises:
a ball head; and
an electromagnet arranged in an interior space of the ball head and configured to generate a magnetic holding force as a safeguard against accidental or unauthorized separation of the coupling between the motor vehicle and the trailer.
